(19) United States
(12) Patent Application Publication
(10) Pub. No.: US 2002/0162618 A1
(43) Pub. Date: Nov. 7, 2002

(54) Process for making adhesive bonded sintered plates

(76) Inventors: David Landa, Pensacola, FL (US); Barry Gindoff, Pensacola, CA (US); Bob Hawkins, (US); Raymond Engel, Pensacola, FL (US)

Correspondence Address: STEPHEN E. FELDMAN, P.C., 12 East 41st Street, New York, NY, 10017, US

(21) Appl. No.: 09/849,467

(22) Filed: May 4, 2001

(51) Int. Cl. C03B 29/00

(52) U.S. Cl. 156/89.16; 156/89.11; 156/153; 156/335

(57) ABSTRACT

The present invention is directed to a method of manufacturing of sintered bonded adhesive plates. The present invention comprises the steps of clearing the metal cores, applying thermosetting adhesives, such as phenolic or epoxy adhesives, to the core layer, then applying sintered layers on top of the adhesive layers and bonding said layers at a temperature in the range of 375-475 F, pressure in the range of 25-1000 psi and bonding such structure for at least 30 seconds. The metal core may be fabricated from metals whose melting point is at least 450 F, such as aluminum. The present invention presents a relatively inexpensive way of manufacturing sintered bonded adhesive plates.

### FIELD OF THE INVENTION

The present invention relates transmissions of a land motor vehicle. In particular, the present invention relates to a field of friction clutch plates. More specifically, the present invention relates to a method of making adhesive bonded sintered friction plates. The present invention establishes an entirely new method of making such plates. Furthermore, the present invention provides a less expensive and more efficient method of bonding materials whose melting point is greater than 450 F, such as aluminum.

### BACKGROUND OF THE INVENTION

There are several known methods for the making of adhesive bonded sintered plates. However, the conventional methods lack the purpose that the present invention so readily provides. Furthermore, the prior art does not achieve the same results as the present invention does. The following is a discussion of such prior art and the reasons for the lack of complacency with the parameters that the present invention has.

U.S. Pat. No. 4,778,548 to Fox et al. teaches a bonding woven carbon fabric friction materials. This particular prior art discloses a porous, woven carbon fabric friction material that is bonded to a solid substrate, such as a conical transmission synchronizer, with a high temperature thermosetting adhesive, such as synthetic rubber-phenolic resin base adhesive. Prior to applying the adhesive, a thin layer of one surface of the friction material is removed such as by contacting the surface with a band-type sander, to break through the pyrolytic carbon coating on the substantial portion of the carbon fibers. The adhesive is applied to the abraded surface of the friction material and/or roughened surface on the solid substrate, the friction material is clamped to the solid substrate and thus-assembled parts are heated to at least substantially cure the adhesive. Improved bonds between the adhesive and friction material are produced and a tendency for the adhesive to “bleed through” the pores of the friction material and migrate to the friction surface during curing us significantly reduced. The present invention comprises a method of making adhesive bonded sintered metal plates. The process comprises the steps of cleaning metal cores, roughening the surface, where the adhesive would be applied, so that the surface would accept a thermosetting phenolic or epoxy adhesive. Then, placing sintered metal lining on one or botch sides of the adhesive coated metal core and bonding the sintered linings under pressure (in the range of 25-1000 psi) and at a temperature (in the range 375-475 F). It is important that the material is bonded for at least 30 seconds. This particular method has an advantage over the prior art because it can be used for bonding of sintered parts with metals having melting temperatures greater than 450 F, such as aluminum. The prior art in question does not allow for such bonding at specified ranges of temperature, time and pressure.

U.S. Pat. No. 5,199,540 to Fitzpatrick-Ellis et al. discloses a friction facing material and carrier assembly. This particular piece of prior are is designed to be used for a clutch driven plate. The assembly comprises two arrays, wherein a first and second arrays are secured, using an adhesive material bonds, to an axis of the clutch driven plate. The adhesive bond that secures the second array comprises an elastomeric material that provides a resilient cushioning relative to the carrier for the second array of friction material. The adhesive bond that secures the first array is axially thinner than the adhesive bond that secures the second array. The present invention is a method for making adhesive bonded sintered metal plates. The method comprises the steps of cleaning the metal cores and roughening the surface to which the thermosetting pheolic or epoxy adhesive would be applied; placing the sintered metal on one or both sides of the adhesive coated metal core and then bonding at a pressure range of 25-1000 psi at a temperature of 375-475 F for a period of at least 30 seconds.

U.S. Pat. No. 5,281,481 to Hayward teaches a method of manufacturing a composite friction element wherein a powdered solventless thermosetting adhesive is applied to a metal substrate and the product made from it. The metal substrate and thermosetting adhesive material are heated to allow the powdered solventless adhesive material to flow but not crosslink. A friction material is applied under the heat and pressure to the adhesive such that the adhesive material crosslinks and a composite element is formed. Furthermore, the adhesive material comprises a resin that contains at least one of the following: 0-70 weight percent range of bisphenol A epoxy resin, unmodified, 0-70 weight percent range of bisphenol A epoxy resin, modified with novolak epoxy, or 0-95 weight percent range of multifunctional epoxy O-cresol novolak resin, and 5-10 weight percent range of bisphenol A epoxy resin with a flow modifier comprising an acrylic acid butyl ester. The present invention is a method of bonding sintered plates using an adhesive. The present invention includes several steps including cleaning the metal core in preparation for application and then later on roughening the application surface so that it would be able to accept a thermosetting phenolic or epoxy adhesive. The present invention bonds the plates at a temperature of 375 F to 475 F at a pressure range of 25-1000 psi for a duration of at least 30 seconds. The present invention allows for bonding of sintered plates, where the metal core may be an aluminum, whose melting point is at 450 F.

The discussed prior art presents a formidable database of information. However, this prior art does not attempt to solve the problems that the present invention is designed to answer. The present invention is a unique variation of a power anchor band that allows driving of a land motor vehicle on rough surfaces or under racing conditions. Due to the specific qualities of the material that is used in manufacturing said power band, the above uses are permitted.

It should be clear to one skilled in the art, that the above discussed prior art is used for the purposes of illustration and should not be construed as limiting in any way, except for the prior art elements claimed in the above patents.

### SUMMARY OF THE INVENTION

The object of the present invention is to provide for a method of making adhesive bonded sintered metal plates.

Another object of the present invention is to provide for a method of making adhesive bonded sintered metal plates wherein said method takes place at a pressure rate between 25 and 1000 psi.

Another object of the present invention is to provide for a method of making adhesive bonded sintered metal plates wherein said method takes place at a temperature rate between 375 F and 475 F.

Another object of the present invention is to provide for a method of making adhesive bonded sintered metal plates wherein said method is performed for at least a period of 30 seconds of time.

Other objects of the present invention will become apparent to one skilled in the art from the following description of the present invention's elements. It should, however, be noted that the present invention is not limited to the embodiments disclosed therein. It is understood that the claims that are follow the description cover a variety of embodiments not necessarily disclosed in the present application.

### BRIEF DESCRIPTION OF THE DRAWINGS

The following description of preferred embodiment of the present invention will be better understood when read in conjunction with the appended drawings. It should be understood, however, that the invention is not limited to the precise arrangements shown in which:

FIG. 1 presents a schematic illustration of the present invention's method steps.

FIG. 2 presents plain view of an outcome after steps of the method in the present invention are applied.

### DESCRIPTION OF THE PREFERRED EMBODIMENT

In the following description, references to the drawings, certain terms are used for conciseness, clarity and comprehension. It is assumed by one skilled in the art that there are to be no unnecessary limitations implied from the references, besides the limitations imposed by the prior art, because such terms and references are used for descriptive purposes only and intended to be broadly construed. Furthermore, the description and the drawings are for illustrative purposes only and not to be construed as limited to the exact details shown, depicted, represented, or described.

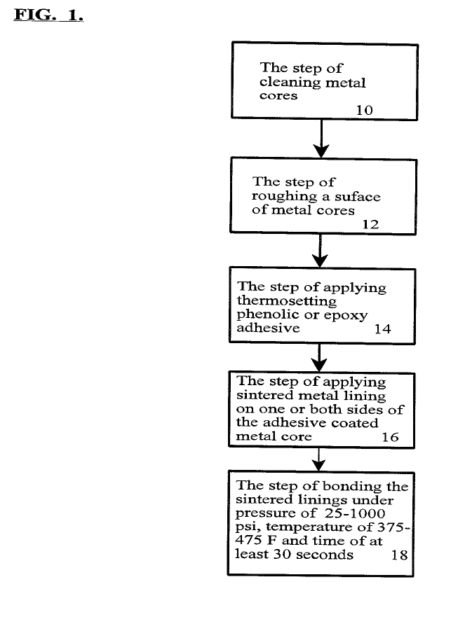

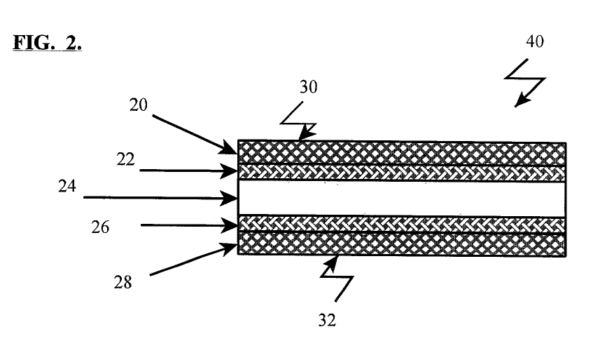

Referring to FIG. 1, the present invention's process is shown. The box labeled 10 indicates that before the process begins to produce the end result depicted in FIG. 2 the metal core 24 should be cleaned on any irregularities, such as corrosions, abrasions or accumulating dusts and other elements that may adversely affect the proper binding of adhesives to the metal core 24. After the metal core 24 is cleaned, if it is necessary the surface of the metal core 24 may be roughened as indicated in the box labeled 12, as shown in FIG. 2. The roughening of the metal core 24 is performed so that the metal core 24 is better able to accept the adhesive 22 and 26, as shown in FIG. 2. When the thermosetting phenolic or epoxy adhesive 22 and/or 26 are applied to the metal core 24 under pressure and temperature, it is vital to the sintered plate 40 that all elements are well bound, otherwise the functionality and lifetime of the sintered plate 40 is greatly reduced. The roughening of step 12 assures such functionality and a longer lifespan of the sintered plate 40.

Referring to FIG. 1, the next step shown in box 14 is applying thermosetting phenolic or epoxy adhesive 22 and/or 26 to the metal core 24, as shown in FIG. 2. The thermosetting phenolic or epoxy adhesive 22 and/or 26 is applied so to prepare the sintered plate 40 and the metal core 24 for the receiving of the sintered metal linings 20 and/or 28, respective of thermosetting phenolic or epoxy adhesive 22 and/or 26. Furthermore, referring to FIG. 1, boxes 16 and 18 describe the final steps of the present invention's method that it results in the sintered metal plate 40 depicted in FIG. 2. Sintered metal lining 20 and/or 28 is respectively applied on top of adhesive layers 22 and/or 26.

Referring to FIG. 1, box 18, the above-described application takes places under certain conditions to ensure proper binding of all layers, as shown in FIG. 2. In one embodiment, the conditions that the binding of the sintered plates takes place are a pressure of 25 to 1000 psi that is applied to the plates. Such scale of pressure ensures proper binding of the components of the sintered plate 40. Furthermore, in another embodiment, the process described in FIG. 1 may take place at a temperature in the range of 375 F to 475 F. Such temperature ensures that the different kinds of metals may be used for the sintered portion(s) 20 and/or 28, as shown in FIG. 2. Moreover, in yet another embodiment, the process of bonding the sintered plates 40 takes place for at least 30 seconds. Such a time interval is necessary for proper adhesion of phenolic or epoxy adhesives 22 and/or 24, as shown in FIG. 2, together with sintered plates layers 20 and/or 28 and the metal core layer 24.

After steps 10 through 18 as shown in FIG. 1 have taken place, the sintered bonded plate 40 is a final result, as shown in FIG. 2. The sintered plate 40 is shown to have a top face 30 and a bottom face 32. In one embodiment, the sintered plate 40 may have both the top face 30 and the bottom face 32. In another embodiment, the sintered plate 40 may have just the top face 30. Depending on the purpose of use of the sintered plate 40, the plate may have both the top and the bottom faces or just a single top face. The sintered plate 40, as shown in FIG. 2, has both the top and the bottom faces 30 and 32, respectively.

Referring to FIG. 2, the sintered plate 40 has a top sintered layer 20 and a bottom sintered layer 28, wherein the top sintered layer 20 is located at the top of the top face 30 and the bottom sintered layer 28 is located at the bottom face 32. The sintered plate 40 has a metal core layer 24. The metal core layer 24 may be of variable thickness, depending on the application of the plate. Moreover, the metal core layer 24 may be fabricated from different metallic elements of variable strength, sturdiness and other characteristics. The metal core layer 24 and the sintered layers 20 and 28 are attached through a process defined in FIG. 1, and by means of top adhesive layer 22 attaching top layer 20 and the metal core 24 and by means of bottom adhesive layer 26 attaching bottom layer 28 and the metal core 24.

The layers 22 and 26 may be fabricated from a phenolic or epoxy adhesives or others that are well known in the art. The sintered layers 20 and 28 may be fabricated from a metal that is capable of performing a specific function that a user has in mind. However, it is vital to keep in mind that the process described in FIG. 1 and above is designed for metals that have a melting temperature, such as aluminum, of at least 450 F. The melting point of the metals used in the structure allows a greater flexibility in terms of variety of materials that the components of the sintered plate 40 may be chosen from. Furthermore, the present invention has another advantage that is closely tied with the subject matter sought to be patented, it is the cost of the making such plate. Because of the particular methods and materials used in the invention, the cost of manufacturing the present invention is significantly lower than of those prior art invention currently available.

In the foregoing description of the invention, reference to the drawings, certain terms, have been used for clarity, conciseness and comprehension. However, no unnecessary limitations are to be implied from or because of the terms used, beyond the requirements of the prior art, because such terms are used for descriptive purposes and are intended to be broadly construed. Furthermore, the description and illustration of the invention are by way of example, and the scope of the invention is not limited to the exact details shown, represented, or described.

While the present invention has been described with reference to specific embodiments, it is understood that the invention is not limited but rather includes any and all changes and modifications thereto which would be apparent to those skilled in the art and which come within the spirit and scope of the appended claims.

What is claimed:

1. The method of manufacturing an adhesive bonded sintered plate, comprising the steps of
cleaning metal cores of irregularities;
roughening a surface of said metal cores to prepare said metal cores for bonding;
applying thermosetting adhesive layers to said metal cores;
applying sintered linings to said thermosetting adhesive layers;
bonding said sintered linings to said thermosetting adhesive layers and said metal cores at a bonding pressure, bonding temperature and a bonding time.

2. The method of claim 1, wherein said thermosetting adhesive is a phenolic thermosetting adhesive.

3. The method of claim 1, wherein said thermosetting adhesive is an epoxy thermosetting adhesive.

4. The method of claim 1, wherein said metal cores are fabricated from aluminum.

5. The method of claim 1, wherein said bonding pressure is in the range of 25 to 1000 psi.

6. The method of claim 1, wherein said bonding temperature is in the range of 375 degrees Fahrenheit to 475 degrees Fahrenheit.

7. The method of claim 1, wherein said bonding time is at least 30 seconds.

8. The method of manufacturing an adhesive bonded sintered plate, comprising the steps of
cleaning metal cores of irregularities;
roughening a surface of said metal cores to prepare said metal cores for bonding;
applying thermosetting adhesive layers to said metal cores;
applying sintered linings to said thermosetting adhesive layers;
bonding said sintered linings to said thermosetting adhesive layers and said metal cores at a bonding pressure, bonding temperature and a bonding time, wherein
a. said bonding pressure is in the range of 25 to 1000 psi;
b. said bonding temperature is in the range of 375 degrees Fahrenheit to 475 degrees Fahrenheit;
c. said bonding time is at least 30 seconds.

9. The method of claim 8, wherein said thermosetting adhesive is a phenolic thermosetting adhesive.

10. The method of claim 8, wherein said thermosetting adhesive is an epoxy thermosetting adhesive.

11. The method of claim 8, wherein said metal cores are fabricated from aluminum.

12. An adhesive bonded sintered plate comprising
a top sintered layer;
a bottom sintered layer;
a top adhesive layer;
a bottom adhesive layer;
a metal core layer;
wherein said top sintered layer is attached to said metal core layer using said top adhesive layer and said bottom sintered layer is attached to said metal core layer using said bottom adhesive layer.

13. The adhesive bonded sintered plate of claim 12, wherein said top adhesive layer and said bottom adhesive layer comprise thermosetting phenolic adhesive.

14. The adhesive bonded sintered plate of claim 12, wherein said top adhesive layer and said bottom adhesive layer comprise thermosetting epoxy adhesive.

15. The adhesive bonded sintered plate of claim 12, wherein said top sintered layer is attached to said metal core layer and said bottom sintered layer is attached to said metal core layer at a bonding temperature, bonding pressure, and a bonding time.

16. The adhesive bonded sintered plate of claim 15, wherein said bonding pressure is in the range of 25 to 1000 psi.

17. The adhesive bonded sintered plate of claim 15, wherein said bonding temperature is in the range of 375 degrees Fahrenheit to 475 degrees Fahrenheit.

18. The adhesive bonded sintered plate of claim 15, wherein said bonding time is at least 30 seconds.

19. The adhesive bonded sintered plate of claim 12, wherein said metal core layer comprises aluminum.

20. An adhesive bonded sintered plate comprising
a top sintered layer;
a bottom sintered layer;
a top adhesive layer;
a bottom adhesive layer;
a metal core layer;
wherein said top sintered layer is attached to said metal core layer using said top adhesive layer and said bottom sintered layer is attached to said metal core layer using said bottom adhesive layer;
wherein said top sintered layer is attached to said metal core layer and said bottom sintered layer is attached to said metal core layer at a bonding temperature, bonding pressure, and a bonding time, wherein
a. said bonding pressure is in the range of 25 to 1000 psi;
b. said bonding temperature is in the range of 375 degrees Fahrenheit to 475 degrees Fahrenheit;
c. said bonding time is at least 30 seconds.

21. The adhesive bonded sintered plate of claim 20, wherein said metal core layer comprises aluminum.

22. The adhesive bonded sintered plate of claim 20, wherein said top adhesive layer and said bottom adhesive layer comprise thermosetting phenolic adhesive.

23. The adhesive bonded sintered plate of claim 20, wherein said top adhesive layer and said bottom adhesive layer comprise thermosetting epoxy adhesive.
